(19) United States
(12) Patent Application Publication
(10) Pub. No.: US 2025/0000033 A1
(43) Pub. Date: Jan. 2, 2025

(54) MOBILE DEVICE DELIVERING LIGHT PULSES AND ITS USE IN THE ELIMINATION OF PATHOGENS

(71) Applicant: UV BOOSTING, Saint-Nom-la-Bretéche (FR)

(72) Inventors: Yves MATTON, Fontenay aux Roses (FR); Nicolas PASCOUAU, Léognan (FR); Hugo GONCALVES, Léognan (FR); Julien LASZLO, Paris (FR)

(73) Assignee: UV BOOSTING, Saint-Nom-la-Bretéche (FR)

(21) Appl. No.: 17/905,928

(22) PCT Filed: Mar. 5, 2021
(86) PCT No.: PCT/EP2021/055541

§ 371 Date: Aug. 16, 2024

(30) Foreign Application Priority Data
Mar. 9, 2020 (FR) FR2002295

(51) Int. Cl. A01G 7/04

(52) U.S. Cl. CPC A01G 7/045

(57) ABSTRACT

A movable device for exposing to light with a view to eliminating pathogens has a first module for emitting light pulses that includes a panel for treating with light and has a second module for adjusting the optical power density of the treating panel and a means of locomotion allowing the device to be moved. The optical power density of the light panel allows a radiation dose between 250 J/m² and 2000 J/m² to be applied to the surface of plant matter. The light pulses delivered to the plant matter have identical or different wavelengths between 200 nm and 750 nm (UV-C, UV-B, UV-A, visible light) and the exposure times are shorter than or equal to four seconds.

The present invention relates to the field of agronomy. More specifically, it relates to a mobile light exposure device for the elimination of pathogens by delivery of light pulses onto plant material, and also to the associated method and uses.

The control of plant-disease pathogens is an important issue today, particularly as it can limit yield reductions and improve crop quality.

Cryptogamic diseases, in the broad sense of that term, now account for about 90% of plant diseases.

A cryptogamic disease, also known as a fungal disease, generally refers to an infection of a plant caused by a fungus.

Most cultivated plants are susceptible to attack by fungi, of which there are many plant-pathogenic species. The symptoms of these cryptogamic diseases are caused by the parasitic action of the fungus and the reaction of the host.

Generally speaking, the evolution of a cryptogamic disease passes through three phases.

The first phase is contamination, which does not give rise to any visible symptoms. During this phase, fungal spores deposited on the plant (for example by wind) germinate and penetrate the interior of the tissues, either through natural openings (stomata, lenticels) or through wounds. In some cases, the fungus can also actively perforate the epidermis of the plant with enzymes.

The second phase, known as infection, is also invisible, at least during the incubation period, during which the fungus advances into the host plant, branches out and gradually invades the cells of the plant tissues.

Finally, the third phase involves the appearance and development of visible symptoms of the disease, accompanied by fruiting of the fungus until the death of the host plant.

To avoid partial or total destruction of the host plant, and in some cases of the crop, it is usually advisable to give treatment before the infection phase or in the early infection period.

The use of phytopharmaceutical products, and more specifically the use of fungicides, is a classic means of combating these cryptogamic diseases.

Indeed, use of phytopharmaceutical products is still the most effective solution for optimising crop yields, in particular by eliminating pathogens and other pests that affect the health of crops.

As part of the development of environmentally friendly agriculture, it is necessary to find more ecologically friendly and, if possible, less costly alternatives to the use of phytopharmaceutical products.

Crop treatment with light is an interesting alternative to the use of phytopharmaceutical products for treating plant diseases.

Indeed, light is one of the most important environmental factors for regulating plant growth and development. Plants need light not only for photosynthesis and growth, but also for regulating development processes (such as flowering and branching). Of all the ultraviolet radiation emitted by the sun, only UV-A (320-400 nm) and UV-B (280-320 nm) reach the Earth's surface, UV-C radiation (200-280 nm) being absorbed by the ozone layer.

However, UV-C light can be created artificially by means of various physical processes. Various types of lamps, including light-emitting diodes (LEDs), low-pressure mercury vapour lamps and xenon lamps, emit UV-C radiation.

UV-C radiation has been known for many years to have inhibiting and damaging effects on organisms.

In plants, the lethal effect of UV-C doses on pathogens present on the surface of fresh fruit and vegetables has been successfully used to control post-harvest diseases by extending their shelf life.

These studies have also shown that hormetic doses, i.e. doses that produce positive biological effects without causing side effects, can be found.

UV-C radiation can currently be used to reduce progression of diseases in field-grown plants.

However, a light exposure time of several minutes and/or an excessively high frequency of application of light exposures prevents producers from adopting this technology. On one hand, because producers, especially in the fields, must be able to process their crops quickly. On the other hand, because the doses that allow effective disinfection with long exposures are generally not compatible with good crop development, generating harmful effects that most notably take the form of burns.

Document WO9533374 discloses the use of a laterally-moving rail vehicle to emit a glow discharge consisting of a mixture of UV-A, B, C, visible and infra-red light. Exposure of the plants to this light discharge lasts less than ten seconds and preferably three seconds. The use of this device is designed for the destruction of unwanted plants.

Document EP3143869 describes a method for stimulating plant resistance to biotic stresses by applying UV-B and/or UV-C for a duration of one second or less at doses of less than 10 KJ/m². However, the method described does not mention use of UV radiation for disinfection on the surface of plant material.

Document EP2272324 discloses the use of a device emitting light at wavelengths within the visible spectrum but also UV-B and UV-C for controlling plant diseases. However, there is no mention of the recommended exposure time; only the total applicable radiation dose per day (0.2 to 10 KJ/m²) is indicated.

Finally, document WO2007/049962 describes the use of a means of transport allowing plants to be conveyed under a light source consisting of at least 90% UV-C for 24 hours at low doses, between 0.002 and 0.15 J/cm². This device is used in the treatment of plants or fungi to control the growth of pathogens and insect pests and also to destroy the aerial parts of the plant. This device does not therefore allow use of UV radiation delivered in the form of light pulses or flashes to eliminate pathogens on the surface of plant material.

In view of the above, one problem that the present invention proposes to solve is to develop an alternative device for disinfecting plant material by eliminating pathogens present on the surface and responsible for diseases.

This alternative should allow plant material to be disinfected without deteriorating and without an adverse effect on quantitative and qualitative growth.

In addition, this device must be low-pollution or even zero-pollution in order to preserve the environment, and also easy to use.

Its applications must be easily realisable at different scales, both in greenhouses and in fields.

The first object of the solution to this problem is a mobile light exposure device for eliminating pathogens by delivering light pulses to plant material, comprising:
a first module for emitting one or more light pulses, comprising at least one light-processing panel;
a second module for adjusting the optical power density of the treatment panel and optionally the temperature of the panel, either remotely or on the device; and
a means of locomotion for moving the device; characterised in that the optical power density of the panel allows a radiation dose of between 250 J/m² and 2000 J/m² to be applied to the surface of the said plant material, in that the light pulses delivered to the plant material have identical or different wavelengths between 200 nm and 750 nm (UV-C, UV-B, UV-A, visible light), and in that the exposure times are four seconds or less, and preferably two seconds or less.

The device can also be adapted to eliminate pathogens by delivering light pulses to a fungus or to micro-organisms or environments obtained from a micro-organism culture.

Surprisingly, the Applicant has successfully demonstrated that radiation, preferably UV-C, delivered in the form of light pulses or flashes, is less harmful compared to longer conventional exposures, typically of one or more minutes.

The Applicant has demonstrated that radiation, in particular UV-C, also has a disinfectant effect on plants, reducing and/or eradicating the presence of pathogens on their surface and thus limiting the development of diseases.

According to additional, non-limiting features, the light pulses delivered by the device to the said plant material have the same or different wavelengths between 200 nm and 280 nm (UV-C), and preferably between 220 nm and 260 nm.

The radiation dose is preferably delivered by the said device in the form of light pulses onto the said plant material and is between 250 J/m² and 2000 J/m² on the surface of plant material and preferably between 500 J/m² and 1500 J/m² on the surface of plant material.

A second object of the invention is a method of eliminating pathogens by delivering light pulses to plant material comprising the following steps:
installation of a device according to the invention on a farm comprising plantations to be treated;
passage of the said device through the plantations, combined with direct exposure of the plant material in the plantations to light pulses of identical or different wavelengths and/or durations,
   characterized in that the wavelengths are identical or different and are between 200 nm and 750 nm (UV-C, UV-B, UV-A, visible light) and preferably between 200 nm and 280 nm (UV-C); and in that the exposure times are identical or different but total four seconds or less and preferably two seconds or less.

According to additional, non-limiting features, the said plant material is a plant material such as a plant, fruit, vegetable, seed, vitro-plant, tuber or any other part of a plant. Preferably, the pathogens are plant pathogens or pests selected from bacteria, viruses, fungi, oomycetes, insects, mites and/or nematodes.

The third object of the invention is the use of a device according to the invention for elimination of pathogens by delivery of light pulses to plant material.

Preferably, the device is used on plant material selected from strawberry, tomato, rose, cucumber, red berries, cannabis, vine, asparagus, potato, grass and apple tree.

Preferably, the device is used to eliminate pathogens that cause cryptogamic diseases.

The final object of the invention is the use of a device for disinfecting the surface of plant material by delivering light pulses to the said plant material.

The invention developed consists of a mobile device for emitting light pulses, with qualities of adaptability and ease of regular use allowing treatment of cultures of varying sizes.

The use of UV radiation in the form of light pulses that allow shorter exposure times is more advantageous for disinfecting plants from pathogens without causing physiological damage.

When used preventively, this approach greatly limits development of cryptogamic diseases.

The Applicant has also demonstrated that the application of light pulses to plant material allows the following in particular:
reduced UV-C application time;
a curative effect on many plant diseases, under controlled conditions or in the field;
a curative effect obtained with doses not hazardous to the plants under cultivation;
a greater level of curative effect compared to conventional UV-C treatments, typically lasting one or more minutes; and
an increased curative effect with repeated treatment throughout the vegetative cycle of the plants, without causing damage to the growth and production of the plant.

The invention and the advantages derived therefrom will be better understood by reading the following description and non-limiting embodiments, illustrated with reference to the appended drawings in which:

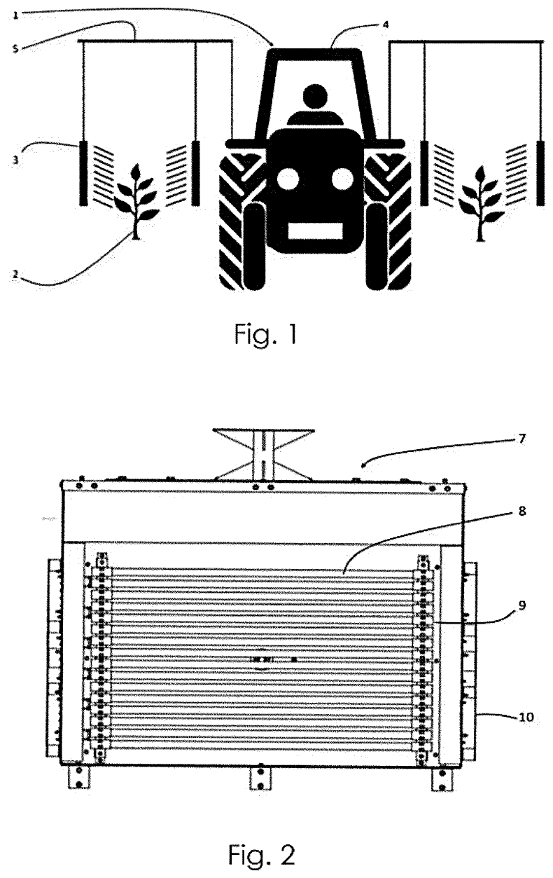

FIG. 1 shows a front view of a device according to the invention, namely a mobile light-exposure module 1 comprising a first double-sided light pulse emission module 3 held by a straddling device 5 mounted on a tractor 4.

FIG. 2 shows a front view of an example of possible structure of a reflector body 7 of a device according to the invention, comprising at least a light source 8, reflectors 9 and a temperature control unit 10.

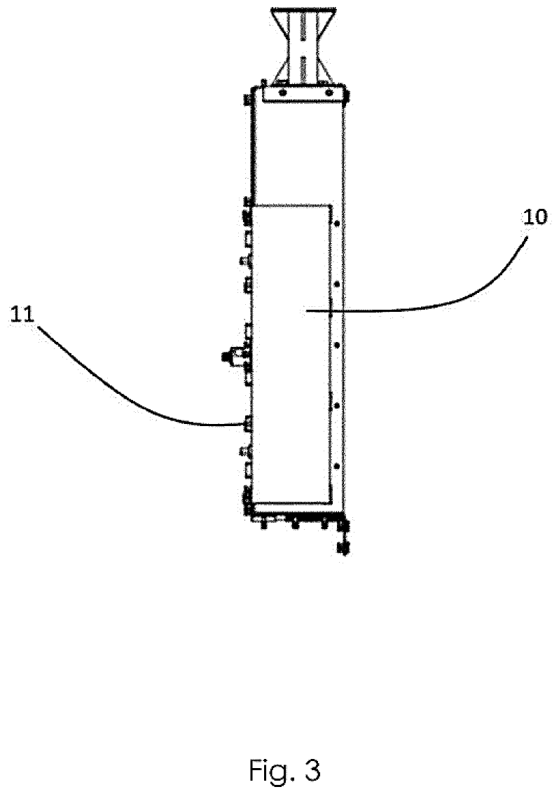

FIG. 3 shows, in profile view, the composition of an example of a reflector body 7 of a device according to the invention, comprising the temperature control unit 10 and a set of temperature and light output sensors 11.

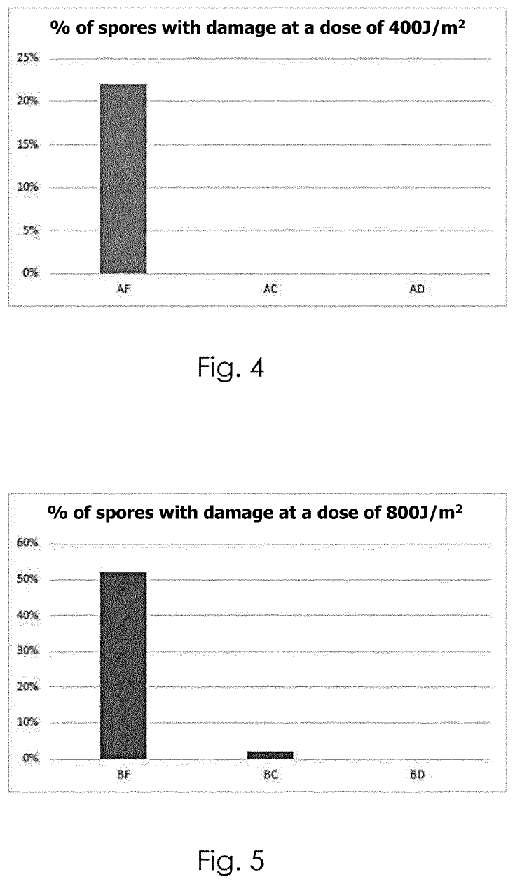

FIG. 4 is a graph associated with Example 1 and showing the effects of a UV-C dose of 400 J/m² according to different modes of administration on Podosphaera aphanis spores in a gariguette strawberry plant (see definition of acronyms in Table 1).

FIG. 5 is a graph associated with Example 1 and showing the effects of a UV-C dose of 800 J/m² according to different modes of administration on Podosphaera aphanis spores in a gariguette strawberry plant (see definition of acronyms in Table 1).

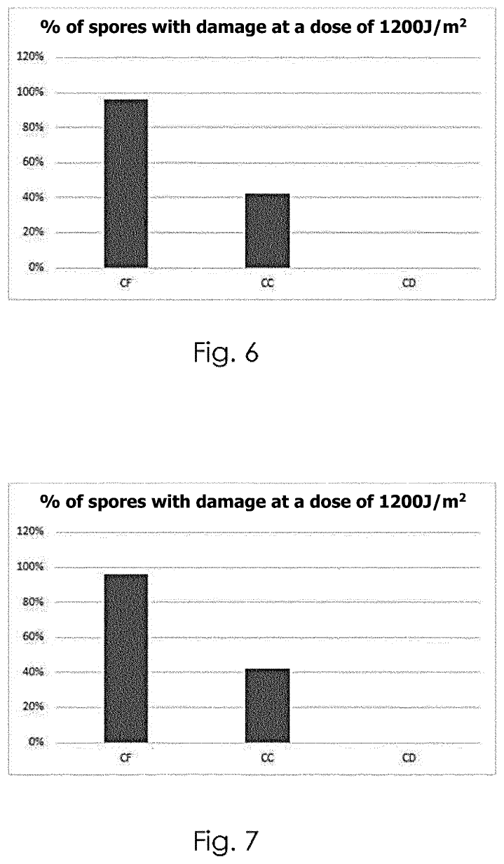

FIG. 6 is a graph associated with Example 1 and showing the effects of a UV-C dose of 1200 J/m² according to different modes of administration on Podosphaera aphanis spores in a gariguette strawberry plant (see definition of acronyms in Table 1).

FIG. 7 is a graph associated with Example 1 showing the effects of a UV-C dose of 1600 J/m² according to different modes of administration on Podosphaera aphanis spores in a gariguette strawberry plant (see definition of acronyms in Table 1).

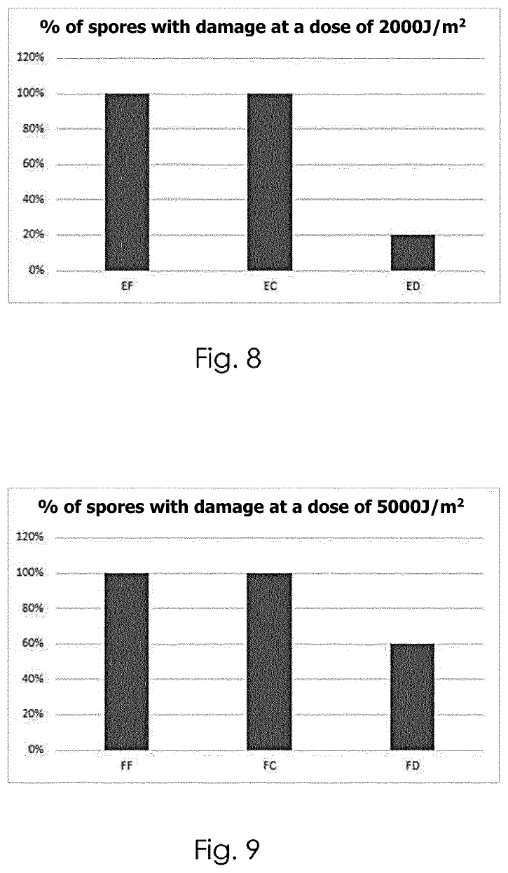

FIG. 8 is a graph associated with Example 1 and showing the effects of a UV-C dose of 2000 J/m² according to different modes of administration on Podosphaera aphanis spores in a gariguette strawberry plant (see definition of acronyms in Table 1).

FIG. 9 is a graph associated with Example 1 and showing the effects of a UV-C dose of 5000 J/m² according to different modes of administration on Podosphaera aphanis spores in a gariguette strawberry plant (see definition of acronyms in Table 1).

In this description, unless otherwise specified, it is understood that when an interval is given, it includes the upper and lower limits of the said interval.

According to the invention, the mobile light exposure device 1 for elimination of pathogens by delivery of light pulses to plant material 2, as illustrated in FIG. 1, comprises a first module 3 for emitting one or more light pulses.

By “light exposure”, the Applicant means one or more light sources 8 originating from the said device and emitting at wavelengths between 200 nm and 750 nm (UV-C, UV-B, UV-A, visible light).

The first module of the mobile light exposure device 1, comprising one or more discharge lamps according to the invention, allows one or more light pulses to be emitted. Non-limiting examples of lamps that can be used are low, medium or high pressure lamps, pulsed light or xenon lamps, Excimer lamps, LED lamps or mercury vapour lamps (especially at 254 nm).

The light pulses delivered to the plant material 2 are characterised in particular by their duration and by their identical or different wavelengths.

The light pulses necessarily last for less than four seconds, and preferably for two seconds or less.

Preferably, the duration of the light pulses is between two seconds and one tenth of a millisecond. More preferably, it is between one second and one hundredth of a second. Particularly preferred values used by the Applicant are one second, one tenth of a second, one hundredth of a second or values between 300 μs and 500 μs.

The number and frequency of the light pulses are modulated according to the nature of the plant material 2 to be treated.

The wavelengths of the light pulses are generally between 200 nm and 750 nm (UV-C, UV-B, UV-A, visible light), and preferably between 200 nm and 280 nm (UV-C). Even more advantageously, they should be between 220 nm and 260 nm. Even more preferably, the light pulses can be UV-C flashes which advantageously last for 1-2 seconds.

The device according to the invention allows the elimination of pathogens by delivering light pulses to plant material 2 as shown in FIG. 1.

The term “plant material” refers to a plant or part of a plant such as a cell, tissue, leaf, fruit, stem, flower, grain or root.

Preferably, the said plant material 2 originates from farms containing plantations. These plantations are within the disciplines of agriculture, forestry or horticulture, such as vegetable, fruit, cereal, oilseed, protein, medicinal or industrial crops.

The following plant families can be listed as non-limiting examples of usable plant material: Actinidiaceae, Amaranthaceae, Apiaceae, Arecaceae, Asteraceae, Brassicaceae, Cannabaceae, Cucurbitaceae, Fabaceae, Liliaceae, Lythracede, Musaceae, Poaceae, Primulaceae, Rosaceae, Rubiaceae, Rutaceae, Solanaceae and Vitaceae.

Another example is grass, that is, any annual or perennial, non-tree-like plant, belonging to the class monocotyledonde and usually green in colour. More specifically, the term “grass” commonly refers to grasses, especially forage grasses, which make up grasslands, meadows and lawns, and the morphologically related families juncaceae (rushes) and cyperaceae (sedges).

Preferably, the plant species used are:
Fragaria virginiana or Fragaria ananassa (strawberry),
Fragaria vesca (wild strawberry),
Vaccinium macrocarpon (large cranberry),
Vaccinium vitis-idaea (lingonberry),
Aronia melanocarpa (black chokeberry),
Vaccinium oxycoccos ((small) cranberry),
Ribes nigrum (blackcurrant),
Lycium barbarum (goji or boxthorn),
Ribes rubrum (redcurrant),
Ribes uva-crispa (gooseberry),
Vaccinium myrtillus (blueberry),
Sambucus nigra (common elder),
Rubus idaeus (raspberry),
Punica granatum (pomegranate),
Prunus avium (cherry),
Rubus fruticosus (blackberry),
Rubus×loganobaccus (loganberry),
Vitis vinifera (vine),
Malus domestica (apple),
Pyrus communis (pear),
Actinidia chinensis (kiwi fruit)
Solanum melongena (aubergine),
Daucus carota (carrot),
Lactuca sativa (lettuce),
Cucumis sativus (cucumber),
Capsicum annuum (pepper),
Solanum tuberosum (potato),
Cucurbita pepo (courgette),
Asparagus officinalis (asparagus),
Rosa hybrida (rose),
Gerbera sp. (gerbera),
Cannabis sativa (cannabis),
Cyclamen sp. (cyclamen).

Preferably, the plant material 2 is selected from strawberry, tomato, rose, cucumber, red berries, cannabis, vine, asparagus, potato, grass and apple. According to the invention, the device allows one or more light pulses to be emitted from one or more light treatment panels.

These light pulses can differ in wavelength, power and/or duration. Similarly, it is possible to consider superimposing different light pulses (in terms of wavelength, duration or power) as the device passes through.

In particular, this allows different light pulses to be used simultaneously, separately or spread out over time.

The first light pulse emission module 3 of the device according to the invention comprises at least one light-processing panel.

According to the invention, the mobile light exposure device 1 for removing pathogens from plant material 2 comprises a second adjustment module 6 (not visible in FIG. 1).

The second adjustment module 6 can be controlled remotely or directly on the device.

Preferably, the second adjustment module 6 allows adjustment both of the optical power density of the treatment panel and of the temperature of that panel.

The temperature of the panel is regulated actively (for example, by a fan) or passively (for example, by a thermal diffuser) by a temperature control unit 10, which changes the temperature on the basis of data that it receives from a temperature sensor 11, as shown in FIG. 3.

More preferably, the second adjustment module 6 controls a mechanical adjustment module that ensures correct positioning of the panels in relation to the plant material 2, especially when the plant material 2 is presented in the form of a low crop.

The optical power density of the panel allows application of a radiation dose to the plant material 2 between 250 J/m² and 2000 J/m² on the surface of a plant material, and preferably between 500 J/m² and 1500 J/m² on the surface of a plant material. The sources used can be discharge lamps (including low, medium or high pressure lamps, pulsed light or Excimer lamps) or LED. The said light sources 8 can be advantageously mounted on a support termed the reflector body 7, with reflectors 9 and the temperature control unit 10, in order to control the light beam as shown in FIG. 2.

Even more preferably, the optical power density of the panel allows application of a radiation dose of between 600 J/m² and 1400 J/m² to the surface of a plant, advantageously between 800 J/m² and 1200 J/m² to the surface of a plant material.

Of course, persons skilled in the art will be able to adapt the above-mentioned settings according to the surface and the plant material 2 to be treated.

According to the invention, the mobile light exposure device 1 for removing pathogens from plant material 2 also comprises a means of locomotion 4 for moving the device. The means of locomotion 4 is advantageously a means of traction or propulsion.

The means of locomotion 4 may or may not have driving wheels capable of moving on all types of surfaces or on rails. Depending on the nature of the surface, it may refer to a traction device consisting of wheels and assisted or not by a motor. Non-limiting examples include, but are not limited to:
a wheelbarrow or trolley;
a locomotion device with wheels running on rails, for example in the form of a specialised treatment trolley:
a tractor coupled to a straddle carrier 5 for the largest surface areas to be treated, or
a storage space with straps to be carried on the back, for example a rucksack.

Preferably, the means of locomotion 4 used is a traction or propulsion device consisting of wheels and assisted by a thermal or electric motor.

The size of the areas to be treated varies and can generally range from 0.001 m² to 100 hectares. Preferably, the surface area of the zones to be treated corresponds to the size of a crop field, nursery, green space or greenhouse, but also to a product obtained after harvest.

The invention also relates to a method of eliminating pathogens by delivering light pulses to plant material 2, comprising the following steps:
installation of a device according to the invention on a farm containing plantations to be treated;
passage of the said device through the plantations combined with direct exposure of the plant material 2 to light pulses of the same or different wavelengths and/or durations,
   characterised in that the wavelengths are identical or different and are between 200 nm and 750 nm (UV-C, UV-B, UV-A, visible light) and preferably between 200 nm and 280 nm (UV-C); and in that the exposure times are identical or different but total four seconds or less and preferably two seconds or less.

Preferably, the process according to the invention is adapted to a plant material 2 which is a plant, fruit, vegetable, seed, vitro plant or tuber or any other part of a plant.

Preferably, the process according to the invention concerns plant pathogens or pests including bacteria, viruses, fungi, oomycetes, insects, mites and/or nematodes.

Preferably, the pathogen is responsible for cryptogamic diseases such as:
Powdery mildew,
Downy mildew,
Sclerotinia,
Fusarium,
Anthracnose,
Black spot,
Rust,
Stemphyliosis,
Moniliasis,
Grey rot.

Non-limiting examples of pathogens causing these diseases include the following genera and species of plant pathogens: Botrytis (Botrytis cinerea), Stemphylium sp, Sclerotinia (Sclerotinia homoeocarpa), Pythium, Fusarium, Phytophthora, Alternaria, Cercospora, Erysiphe (Erysiphe necator), Sphaerotheca, Verticillium, Tobacco mosaic virus, Xanthomonas, Pseudomonas, Stemphylium, Septoria, Peronospora, Erwinia, Mycosphaerella, Albugo, Cladosporium, Microdochium, Colletotrichum, Clavibacter and Podosphaera (Podosphaera aphanis and Podosphaera myrtillina).

The invention also relates to use of a device according to the invention for elimination of pathogens by delivering light pulses to the said plant material 2.

The final object of the invention is use of a device according to the invention for disinfecting the surface of a plant material 2 by delivering light pulses to the said plant material 2.

Removal of pathogens and disinfection of the surface of a plant material is achieved wholly or partly, depending on the dosages to which the plants are exposed.

Advantageously, removal of pathogens and disinfection of the surface may also involve a fungus or micro-organisms or environments originating from culture of micro-organisms.

Surprisingly, the Applicant has also demonstrated that the use of the device according to the invention, and in particular the application of light pulses to a plant material 2, produced the following effects:
reduced UV-C application time;
a curative effect on many plant diseases, under controlled conditions or in the field;
a curative effect obtained with doses not hazardous to the plants under cultivation;
a greater curative effect compared to conventional UV-C treatments lasting one or more minutes; and
an increased curative effect with repeated treatment throughout the vegetative cycle of the plants, without causing damage to the growth and production of the plant.

Thus, the results obtained by using this invention may also be applicable in the following areas, as non-limiting examples:
pharmacology,
cosmetics,
the paper and paper products industry,
the perfume and fragrance industry,
the ‘green’ chemical industry,
the food industry,
the animal feed industry,
nutraceuticals.

This invention will now be illustrated using the following examples.

Different tests were carried out on strawberry (Fragaria ananassa) leaves contaminated by different types of colonies in order to observe the effects of UV-C. The effects of UV-C were also observed on the pathogens Podosphaera aphanis and Botrytis cinerea.

### EXAMPLE 1

### Effect of UV-C on Viability of Spores of Podosphaera aphanis in the Gariguette Strawberry

A solution of powdery mildew (Podosphaera aphanis) spores extracted from highly mildewed and sporulating strawberry leaves was prepared with sterile water to obtain a concentrated solution at 106 per ml after spore count on a Malassez cell.

The solution thus prepared was deposited on different microscope slides and then exposed to UV-C. The exposure methods are shown in the table below:

TABLE 1

| | | | | | Total |
|---|---|---|---|---|---|
| | 1. | 2. | 3. | 4. | dose |
| Methods | Control | Flash | Sixty seconds | Fixed power | applied |
| A | No | AF | AC | AD 6.67 W/m² × | 400 J/m² |
| | exposure | 400 W/m² × 1 | 6.67 W/m² × | 60 s = 400 J/m² | |
| | | s = 400 J/m² | 60 s = 400 | | |
| | | | J/m² | | |
| B | No | BF | BC | BD | 800 J/m² |
| | exposure | 800 W/m² × 1 | 13.33 W/m² × | 6.67 W/m² × 120 s = | |
| | | s = 800 J/m² | 60 s = 800 | 800 J/m² | |
| | | | J/m² | | |
| C | No | CF | CC | CD | 1200 |
| | exposure | 1200 W/m² × | 20 W/m² × 60 s = | 6.67 W/m² × 180 s = | J/m² |
| | | 1 s = 1200 | 1200 J/m² | 1200 J/m² | |
| | | J/m² | | | |
| D | No | DF | DC | DD | 1600 |
| | exposure | 1600 W/m² × | 26.66 W/m² × | 6.67 W/m² × 240 s = | J/m² |
| | | 1 s = 1600 | 60 s = 1600 | 1600 J/m² | |
| | | J/m² | J/m² | | |
| E | No | EF | EC | ED | 2000 |
| | exposure | 2000 W/m² × | 33.33 W/m² × | 6.67 W/m² × 300 s = | J/m² |
| | | 1 s = 2000 | 60 s = 2000 | 2000 J/m² | |
| | | J/m² | J/m² | | |
| F | No | FF | FC | FD | 5000 |
| | exposure | 5000 W/m² × | 83.33 W/m² × | 6.67 W/m² × 750 s = | J/m² |
| | | 1 s = 5000 | 60 s = 5000 | 5000 J/m² | |
| | | J/m² | J/m² | | |

Six doses, labelled as Methods A to F, were applied to microscope slides prepared in three different exposure modes (with the first mode serving as a control, no dose was delivered).

The first method noted (1. Control) is used as a control and no microscope slide is exposed to any light. No UV-C dose is therefore delivered.

The second method noted (2. Flash) consists of exposure to a UV-C flash lasting one second. This means that the total measured UV-C dose is delivered in one second. For example, for method A, the microscope slide is exposed to a one-second UV-C flash delivering a power of 400 W/m² to the surface of the spore solution in one second, making a total dose of 400 J/m² on the surface of the spore solution. This method is marked with the letter F. The third method noted (3. Sixty seconds) consists of exposure to UV-C lasting sixty seconds. This means that the total measured UV dose is delivered in sixty seconds. The power delivered per second is shown for each method in Table 1. For example, for method B, the microscope slide is exposed to a UV-C source for 60 seconds delivering a power of 13.33 W/m² on the surface of the spore solution, per second for 60 seconds, making a total dose of 800 J/m² on the surface of the spore solution. This method is marked with the letter C.

The fourth method noted (4. Variable duration) consists of exposure to UV-C for a variable period. The UV-C dose delivered is set at the value of 6.67 W/m² at the surface of the spore solution, and the exposure time is set to reach the total measured dose. For method C, for example, the microscope slide is exposed to a UV-C source for 180 seconds, delivering a power of 6.67 W/m² to the surface of the spore solution for 180 seconds, making a total dose of 1200 J/m² on the surface of the spore solution. This method is marked with the letter D.

Each of these tests was carried out five times and photographs were taken under a light microscope to count the number of spores after exposure to UV-C.

The aim is to identify spores damaged by UV-C exposure. This damage is characterised by drying out of spores and destruction of organelles.

The results are shown in FIGS. 4 to 9.

FIG. 4 shows that at a dose of 400 J/m², the only damage to the spores is caused by exposure in the form of flashes.

FIG. 5 illustrates that at a dose of 800 J/m², more than 50% of the spores are damaged by exposure in the form of flashes. However, the other methods of exposure show little or no damage to the spores.

FIG. 6 illustrates that at a dose of 1200 J/m², almost 100% of the spores are damaged by exposure in the form of flashes. The third exposure method causes damage to about 40% of spores, while the fourth method does not cause any damage to the spores.

FIGS. 7, 8 and 9 show that between 1600 J/m² and 2000 J/m², a threshold level, at which all spores present are damaged or even exploded, is reached. The exception is the fourth exposure method, which barely exceeds 60% for a dose of 5000 J/m².

### Conclusion:

FIGS. 4 to 9 show that application of UV-C flashes is more effective than other methods of application, regardless of the total dose applied.

However, in order to eliminate all spores effectively, a dose of between 1200 J/m²J and 1600 J/m² must be administered in the form of UV-C flashes.

### EXAMPLE 2

### Effect of UV-C on Gariguette Strawberry Plants

In parallel to the tests carried out in Example 1, the application of different doses of UV-C in different methods was also tested on strawberry plants.

Only the flash and 60-second exposure methods were tested at the following doses: 400 J/m², 800 J/m², 1200 J/m², 1600 J/m², 2000 J/m² and 5000 J/m².

The aim was to verify the real effect of these doses on the strawberry plants.

The results of these tests do not show any damage to the plants for the 400 J/m², 800 J/m² and 1200 J/m² doses, this being for exposures carried out over one second or sixty seconds. Damage begins to occur at a dose of 1600 J/m², both for 1-second and for 60-second exposures. This damage takes the form of light leaf burns at a dose of 1600 J/m², severe leaf burns at a dose of 2000 J/m², and leaf death at a dose of 5000 J/m².

### Conclusion:

The results show that the doses that do not damage strawberry plants are between 400 J/m² and 1200 J/m². According to the results of Example 1, at equivalent doses, the effect obtained is higher for UV-C flashes.

UV-C flashes are therefore more effective in eliminating pathogens than 60-second exposures.

The 60-second exposure does not provide sufficient efficiency of disinfection coupled with good plant health. Indeed, if the dose is increased, it affects the plant and UV burns appear on the leaves.

### EXAMPLE 3

### Effect of UV-C on Development of Botrytis cinerea

A PDA (potato dextrose agar) culture medium was prepared (concentration of 39 g/L) and then poured into Petri dishes in sterile medium near a Bunsen bumer. A solution of Botrytis cinerea spores, concentration 10⁶ per ml, was prepared after counting the spores on a Malassez cell.

A drop of this solution was placed in the centre of several Petri dishes.

For each method, three Petri dishes were used.

The methods tested are the following:
TNT: Untreated control (“Témoin non traité” in French)
FD1: UV-C flash at dose of 800 J/m² in 1 second
CD1: Exposure to UV-C at power of 13.33 W/m² on surface of spores for 60 seconds, making a total dose of 800 J/m² on the surface of the spores.

The Petri dishes are exposed to UV-C or otherwise under sterile conditions, according to the different methods mentioned, and then left in culture for 48 hours.

After 48 hours, the diameters of the colonies are measured and the average of these diameters is calculated for each method.

The results are shown in the table below and different letters indicate significant differences between the various results:

TABLE 2

| | Colony diameter (cm) | Average diameter (cm) |
|---|---|---|
| TNT-A | 5.8 | 6.2 + 0.28 a |
| TNT-B | 6.4 | |
| TNT-C | 6.4 | |
| FD1-A | 4.4 | 4.6 + 0.20 a |
| FD1-B | 4.9 | |
| FD1-C | 4.6 | |
| CD1-A | 5.6 | 5.6 + 0.22 ab |
| CD1-B | 6.2 | |
| CD1-C | 5 | |

### Conclusion:

On average, the smallest diameter is obtained for the FD1 method consisting of one second of exposure to a UV-C flash.

The UV-C flashes therefore produce a lower development diameter of Botrytis cinerea compared with the control and UV methods in 60 seconds (Modality CD1).

The UV-C flashes provide added value compared to the UV-C produced in 60 seconds, although the total dose of UV-C delivered is identical (800J/m²).

### EXAMPLE 4

### Effect of UV-C on Micro-Organisms Present on the Surface of Leaves of Gariguette Strawberry Plants

A PDA (potato dextrose agar) culture medium was prepared (concentration of 39g/L) and then poured into Petri dishes in sterile medium near a Bunsen burner.

15 young gariguette strawberry plants with an identical development stage (20 days after planting) were selected.

Each strawberry plant was exposed one by one to UV-C radiation using three different methods.

For each modality, five Petri dishes and five strawberry plants were used.

The methods tested are the following:
TNT: Untreated control
FD1: UV-C flash at dose of 800 J/m² on the surface of a plant material, for 1 second (800 W J/m²)
CD1: Exposure to UV-C at a power of 13.33 W/m², for 60 seconds, i.e. a total dose of 800 J/m² on the surface of a plant material.

A leaf of the same size is then taken from each strawberry plant (still under sterile conditions) in order to make an impression on the PDA culture medium using simple pressure.

The impression is made from the top side of the sheet exposed to UV-C radiation.

The Petri dishes are left in culture for 48 hours.

After 48 hours, the total number of colonies is counted and the colonies are classified according to their colour by method.

One colour corresponds to a specific type of colony.

The results obtained are shown in the following table.

TABLE 3

| | | | Total colonies per | |
|---|---|---|---|---|
| | Colony colour | Number | dish | Total colony type |
| FD1-A | Grey | 6 | 16 | 5 |
| | White | 3 | | |
| | Translucent | 5 | | |
| | Yellow | 1 | | |
| | Pink | 1 | | |
| FD1-B | Black | 2 | 8 | 3 |
| | Grey | 3 | | |
| | Translucent | 3 | | |
| FD1-C | Black | 1 | 6 | 3 |
| | Grey | 2 | | |
| | Translucent | 3 | | |
| FD1-D | Grey | 6 | 12 | 3 |
| | White | 2 | | |
| | Translucent | 4 | | |
| FD1-E | Black | 2 | 6 | 2 |
| | Translucent | 4 | | |
| CD1-A | Black | 2 | 26 | 5 |
| | Grey | 5 | | |
| | White | 3 | | |
| | Translucent | 15 | | |
| | Yellow | 1 | | |
| CD1-B | Black | 4 | 24 | 5 |
| | Grey | 7 | | |
| | White | 2 | | |
| | Translucent | 10 | | |
| | Yellow | 1 | | |
| CD1-C | Black | 5 | 30 | 5 |
| | Grey | 8 | | |
| | White | 2 | | |
| | Translucent | 14 | | |
| | Yellow | 1 | | |
| CD1-D | Black | 1 | 17 | 5 |
| | Grey | 3 | | |
| | White | 1 | | |
| | Translucent | 10 | | |
| | Yellow | 2 | | |
| CD1-E | Black | 9 | 34 | 5 |
| | Grey | 5 | | |
| | White | 4 | | |
| | Translucent | 14 | | |
| | Yellow | 2 | | |
| TNT-A | Black | 10 | 40 | 5 |
| | Grey | 11 | | |
| | White | 3 | | |
| | Translucent | 12 | | |
| | Yellow | 4 | | |
| TNT-B | Black | 4 | 26 | 6 |
| | Grey | 12 | | |
| | White | 3 | | |
| | Translucent | 4 | | |
| | Yellow | 2 | | |
| | Sporulation | 1 | | |
| TNT-C | Black | 4 | 25 6 | |
| | Grey | 5 | | |
| | White | 4 | | |
| | Translucent | 7 | | |
| | Yellow | 4 | | |
| | Sporulation | 1 | | |
| TNT-D | Black | 3 | 21 6 | |
| | Grey | 6 | | |
| | White | 1 | | |
| | Translucent | 8 | | |
| | Yellow | 2 | | |
| | Pink | 1 | | |
| TNT-E | Black | 3 | 31 | 6 |
| | Grey | 10 | | |
| | White | 4 | | |
| | Translucent | 10 | | |
| | Yellow | 2 | | |
| | Pink | 2 | | |

The average number of colony types and the average number of total colonies are shown in the following table:

TABLE 4

| | Average colony | Average number of |
|---|---|---|
| | type | colonies |
| FD1 | 3.2 | 9.6 |
| CD1 | 5 | 26.2 |
| TNT | 5.8 | 28.6 |

For the Untreated Control, there is an average of 5.8 different colony types per box, with a total average number of 28.6 colonies per box.

On average, 5 different types of colonies are found when the Petri dishes are exposed using the CD1 method, with an average total of 26.2 colonies.

The UV-C flashes (Method FD1) allow a greater variety of colonies (bacteria or fungi) to be destroyed, with an average of 3.2 different types of colonies. Similarly, the total number of colonies present per dish is significantly reduced, totalling 9.6 colonies per dish. Conclusion:

The UV-C flashes provide added value compared to the UV-C applied over 60 seconds, although the total dose of UV-C delivered is identical (800J/m²).

Indeed, it is evident that the total number of colonies, and the type of colonies found in the boxes, is significantly reduced with the UV-C flashes (Method FD1) compared to the two other methods.

1. A mobile light exposure device (1) for eliminating pathogens by delivering light pulses to plant material (2), comprising:
a first module (3) for emitting one or more light pulses, comprising at least one light processing panel;
a second module (6) for adjusting, the optical power density of the treatment panel and possibly the temperature of the panel, remotely or on the device; and
a means of locomotion (4) for moving the device;
wherein the optical power density of the panel allows a radiation dose of between 250 J/m² and 2000 J/m² to be applied to the surface of the said plant material, in that the light pulses delivered to the plant material (2) have identical or different wavelengths of between 200 nm and 750 nm (UV-C, UV-B, UV-A, visible light), and in that the exposure times are four seconds or less.

2. Device according to claim 1, wherein the light pulses delivered to the said plant material (2) have the same or different wavelengths, between 200 nm and 280 nm (UV-C).

3. Device according to claim 1, wherein the radiation dose delivered in the form of light pulses to the said plant material (2) is between 250 J/m² and 2000 J/m² on the surface of plant material.

4. A method of eliminating pathogens by delivering light pulses to plant material (2), comprising the following steps:
installation of a device according to claim 1 on a farm comprising plantations to be treated;
passage of the said device through the plantations combined with direct exposure of the said plant material (2) in the plantations to light pulses of identical or different wavelengths and/or durations,
characterized in that the wavelengths are identical or different and are between 200 nm and 750 nm (UV-C, UV-B, UV-A, visible light) and preferably between 200 nm and 280 nm (UV-C);
and in that the exposure times are identical or different but total four seconds or less.

5. Method according to claim 4, wherein said plant material (2) is a plant material such as a plant, fruit, vegetable, grain, vitro plant or tuber or any other part of a plant.

6. Method according to one of claims 4, wherein the pathogens are plant pathogens or pests selected from bacteria, viruses, fungi, oomycetes, insects, mites and/or nematodes.

7. (canceled)

8. Method according to claim 4, wherein the said plant material is selected from strawberry, tomato, rose, cucumber, red berries, cannabis, vine, asparagus, potato, grass and apple.

9. Method according to one of claim 4, wherein the said pathogen is responsible for cryptogamic diseases.

10. The device according to claim 1, wherein the radiation dose disinfects the surface of plant material.

11. Device according to claim 1, wherein that the exposure times are two seconds or less.

12. The device according to claim 1, wherein the light pulses delivered to the said plant material have the same or different wavelengths between 220 nm and 260 nm.

13. The device according to claim 1, wherein the radiation dose delivered in the form of light pulses to the said plant material (2) is between 500 J/m² and 150000 J/m² on the surface of plant material.
